(19) United States
(12) Patent Application Publication
(10) Pub. No.: US 2023/0070911 A1
(43) Pub. Date: Mar. 9, 2023

(54) REMOVABLE VEHICLE PANEL GUARD PAD

(71) Applicant: Trent Lecky, Buderim (AU)

(72) Inventor: Trent Lecky, Buderim (AU)

(21) Appl. No.: 17/899,755

(22) Filed: Aug. 31, 2022

(30) Foreign Application Priority Data
Sep. 5, 2021 (AU) 2021225260

(51) Int. Cl. B60J 11/06

(52) U.S. Cl. CPC B60J 11/06

(57) ABSTRACT

A removable vehicle panel guard pad is configured to protect an exterior panel of a vehicle from external damage. The removable vehicle panel guard pad includes a weather resistant front outer layer. A rear outer layer is adapted to minimise scratching of the exterior panel during placement of the pad on the exterior panel of the vehicle. An inner layer is adapted to absorb the impact of any contact of the exterior panel by an external element, such as a door of another vehicle. The inner layer has a magnetic securing element that is adapted to magnetically secure the pad to the exterior panel of the vehicle. A tether is adapted to secure the pad to an attachment point inside the vehicle.

### CROSS-REFERENCE TO RELATED APPLICATION

This application claims priority to and the benefit of the filing date of Australian Patent Application No. 2021225260, filed Sep. 5, 2021, the entirety of which is hereby incorporated by reference herein.

### TECHNICAL FIELD

The present invention relates to a removable vehicle panel guard pad to protect an exterior panel of a vehicle, such as a car, truck or bus, from damage.

### BACKGROUND

Vehicles, such as cars, typically have exterior panels made from metal which provide the outer surfaces of the car. These outer surfaces are exposed to external forces and environmental conditions and as such are susceptible to damage from external elements including impacts from other vehicles.

A very common scenario, in the daily usage of a car, is that when parallel parked the door of an adjacent car will open and impact an exterior panel of the car causing damage to the panel. The damage may include scraping the paint from the panel, denting the panel or even penetrating the panel.

To this end, devices have been developed that aim to protect exterior panels of cars.

Some devices involve attaching a strip of energy absorbing material on an area of the panel that is the most exposed to impact, for example at the apex of the panel.

Other devices involve attaching a rigid pad that covers a larger area of the panel when compared with the strip.

### SUMMARY OF THE DISCLOSURE

The Applicant identified that known devices for protecting exterior panels of cars have a number of disadvantages:
1. They may lack durability in all weather conditions.
2. They may be easily removed/stolen from the car.
3. They may damage the exterior panel during placement of the device on the exterior panel.

The invention provides a removable vehicle panel guard pad (referred to herein also as a “pad”) to protect an exterior panel of a vehicle from external damage, the pad comprising: a weather resistant front outer layer; a rear outer layer adapted to minimise scratching of the exterior panel during placement of the pad on the exterior panel of the vehicle; an inner layer adapted to absorb the impact of any contact of the exterior panel by an external element, such as a door of another vehicle, the inner layer having a magnetic securing element that is adapted to magnetically secure the pad to the exterior panel of the vehicle; and a tether adapted to secure the pad to an attachment point inside the vehicle.

As such, the present invention addresses the issues outlined above by:
1. The weather resistant front outer layer improves durability in all weather conditions.
2. The tether secures the pad against unauthorised removal/theft from the car.
3. The rear outer layer protects the car exterior during placement of the device on the exterior panel as it minimises scratching of the exterior panel.

In the context of this application, the term “weather resistant” should be taken to have its ordinary meaning of able to withstand exposure to weather without damage or loss of function. Loss of function can be considered to include being able to protect the exterior panel of the vehicle from damage. Weather may include: rain (i.e. water resistant); snow; hail; sun exposure i.e. ultraviolet light; high temperatures (up to 45° C.); low temperatures (−10° C.); and frost.

Terms such as “minimise scratching” and “scratch resistant” mean that the panel is not easily damaged, by scratching, during placement of the pad on the vehicle.

Terms such as “adapted to absorb the impact” and “impact absorbing” mean that a significant proportion of the impact energy is converted from kinetic energy to another form of energy, such as heat.

The term “material” includes woven material, unwoven material, synthetic material, natural material, and composites.

As the pad is made from a plurality of layers, each layer can be optimised for a particular purpose.

As the outer layers are configured to provide weather resistance and scratch resistance, it is possible to optimise the inner layer for maximum impact absorption capability without having consideration to these factors.

Suitably, the inner layer is fully enclosed by the front and rear outer layer.

By locating the magnetic securing elements within the inner layer, the magnetic securing elements are concealed within the outer layers which minimises their propensity to scratch the exterior panel during placement of the pad on the vehicle.

The pad may be flexible. The pad may be deformed or distorted from an original condition, whilst being able to return back to the original condition. In other words, the pad may be elastically deformable.

An advantage of the pad being flexible is that it enables the pad to conform to the shape of the exterior panel.

The pad may be transitioned between an extended configuration and a collapsed configuration.

The pad may be rollable so as to form a tube in the collapsed configuration.

The pad may be divided into a plurality of sub-panels that are connected to each other and foldable relative to each other. The pad may have any number of sub-panels.

Suitably, the sub-panels may be concertinaed. In other words, the sub-panels may extend, compress, or collapse in folds like those of a concertina. This allows the collapsed configuration to occupy significantly less area than the extended configuration, which makes the pad easier to transport and store in the collapsed configuration than would otherwise be possible.

An advantage of a flexible/collapsible pad is that it is easier to transport than the large rigid pads previously referred to.

The pad may comprise a fastening element for securing the pad in the collapsed configuration. The fastening element therefore prevents unintended extension of folded sub-panels from the collapsed configuration to the extended configuration.

The fastening element may comprise a plurality of hook elements which interact with a plurality of loop elements (for example VELCRO®).

The fastening element may also comprise friction fit/snap fit fasteners, such as press studs.

In some embodiments, it may be desirable for the pad to be reversible. In this regard, the front and rear outer layers may be both weather resistant. Similarly, it is also envisaged that the front and rear outer layers may be both adapted to minimise scratching the pad on the exterior panel of the vehicle. Similarly, it is also envisaged that the front and rear outer layers may be weather resistant and be adapted to minimise scratching the pad on the exterior panel of the vehicle.

The front outer layer and rear outer layer may be less than or equal to 2 mm in thickness. Suitably, the thickness of the front outer layer and rear outer layer may be between 0.05 mm and 0.50 mm. More suitably, the thickness of the front outer layer and rear outer layer may be between 0.08 mm and 0.18 mm (e.g. 80-200 gsm).

The inner layer may be less than 10 mm in thickness. Suitably, the thickness of the inner layer may be between 5.0 mm and 10 mm. More suitably, the thickness of the inner layer may be between 4.0 mm and 8.0 mm.

Weather resistant materials may include aluminium (e.g. aluminium film), polyvinylchloride (PVC), nylon, polyester, neoprene, taffeta, marine fabric (e.g. sailcloth) or any other suitably water resistant synthetic or natural material. A material may be selected that is not inherently weather resistant provided that it becomes weather resistant as a result of a manufacturing process or treatment process. Scratch resistant materials include polyester, nylon, taffeta, polyvinylchloride (PVC) or any other suitably scratch resistant synthetic or natural material. A material may be selected that is not inherently scratch resistant provided that it becomes scratch resistant as a result of a manufacturing process or treatment process.

Impact resistant materials may include neoprene, cotton wadding, rubber, closed cell polyurethane (PU) foam, open cell polyurethane (PU) foam, ethylene-vinyl acetate (EVA) foam, shear-thickening fluids such as D3O® or any other suitably impact resistant synthetic or natural material.

The at least one inner layer may be a composite.

In some embodiments, the composite inner layer may comprise a plurality of layers of different material that are secured together, for example in a tiered configuration.

In some embodiments, the composite inner layer may comprise a material that is embedded of impregnated with another material, for example as a matrix. Suitable composites may include fibre reinforced polymers such as Kevlar®.

The magnetic securing element may comprise a plurality of magnets, each magnet located around a perimeter of the pad. Having the magnet located about the perimeter of the pad, as opposed to at a centre of the pad, means that the pad can be more efficiently secured to the panel. In other words, fewer magnets are required to secure the pad to the panel than would otherwise be required.

The tether may be flexible. However, it is also envisaged that the tether may be formed from a plurality of connected rigid elements, such as chain-links.

The tether may be inelastic. However, it is also envisaged that the tether may be elastic.

The tether may be retractable.

The tether may have an engagement element that is configured to engage with the attachment point inside the vehicle. Suitably, the attachment point is a seat buckle.

In this regard, the tether can be fed through a partially open window or through a gap between the door and the door frame of the vehicle to enable it to engage with the attachment point inside the vehicle.

As the attachment point is inside the vehicle, it is more difficult to access than would otherwise be the case if the attachment point was external of the vehicle. This enhances security against theft of the pad from the vehicle.

The tether may be rotatably connected to the engagement element.

The engagement element may be a hook. The engagement element may be a swivel hook. The swivel hook may be made from any suitable material. In some embodiments, the swivel hook may made from a polymer or a metal alloy or a combination of both.

The engagement element may comprise a tie that is tied around the attachment point and secured by knotting the tie.

The engagement element may comprise a clamp.

The engagement element may comprise a buckle that is can be fitted to a seat belt, for example by threading the seat belt through an opening in the buckle. The buckle may be G-shaped.

The engagement element may comprise a male element that is receivable within a female element to secure the male element to the female element.

The male element may comprise a tongue and the female element may comprise an opening, wherein the tongue can be inserted into an opening of a female element in a first rotational orientation and prevented from exiting the opening when the tongue is in a second rotational orientation that is offset from the first rotational orientation. Suitably, the first and second rotational orientations are offset by between 10° and 120°, optionally, by between 10° and 90°, optionally, by approximately 45°.

The female element may be couplable to an attachment point inside the vehicle. The attachment point may be a seat belt strap.

The male element may be a male surcingle.

The female element may be a female surcingle.

The male element may be a clip and the female element may be a seat belt buckle. For example, the clip may have a shape and size similar to a latch plate of a seat belt such that it can be received within an opening in the seat belt buckle and secured thereto in a similar manner to how a conventional seat belt latch plate is secured to a seat belt buckle.

### BRIEF DESCRIPTION OF THE DRAWINGS

Notwithstanding any other forms which may fall within the scope of the removable vehicle panel guard pad as set forth in the Summary of the Disclosure, a specific embodiment will now be described, by way of example only, with reference to the accompanying drawings in which:

FIG. 1 is a side schematic view of a vehicle with a removable vehicle panel guard pad according to an embodiment of the present invention.

FIG. 2 is a plan view of a removable vehicle panel guard pad according to an embodiment of the present invention.

FIG. 3 is a cut-away view of the removable vehicle panel guard pad shown in FIG. 2.

FIG. 4 is an exploded view of a removable vehicle panel guard pad according to another embodiment of the present invention.

FIG. 5A is a plan view of a removable vehicle panel guard pad according to another embodiment of the present invention.

FIG. 5B is an enlarged view of the magnetic securing element shown in FIG. 5A.

FIG. 6A is a plan view of a removable vehicle panel guard pad according to yet another embodiment of the present invention.

FIG. 6B is an enlarged view of the tether and engagement element shown in FIG. 6A.

### DETAILED DESCRIPTION OF SPECIFIC EMBODIMENTS

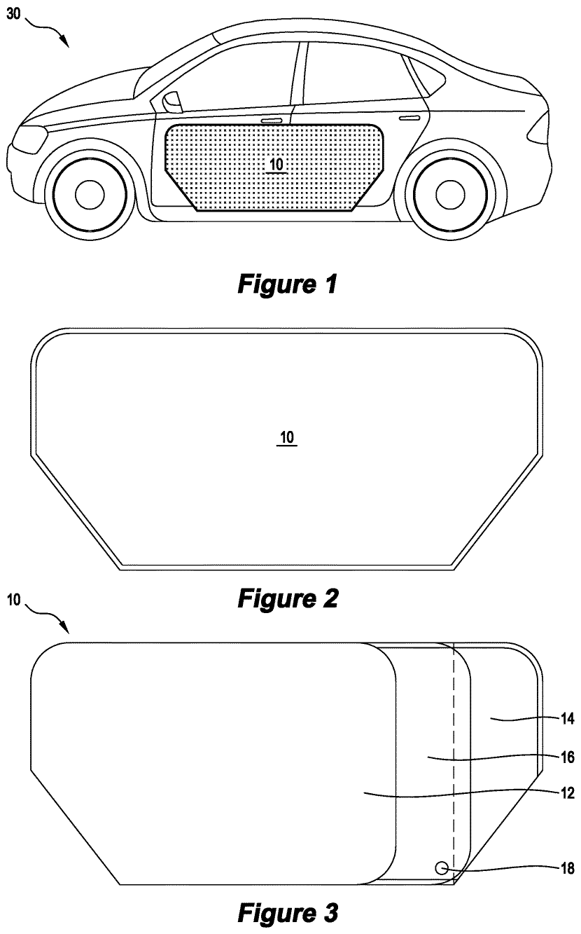

FIGS. 1-3 show a removable vehicle panel guard pad 10 that is attached to an exterior panel of a car 30 to protect it from external damage.

As shown in FIGS. 2 and 3, the removable vehicle panel guard pad 10 is formed from a multi-layer structure comprising a front outer layer 12, a rear outer layer 14, and an inner layer 16. The inner layer 16 is fully enclosed by the front and rear outer layers 12, 14.

The inner layer 16 has a magnetic securing element, in the form of button magnet 18, that is adapted to magnetically secure the pad 10 to the exterior panel of the vehicle.

The front outer layer 12 is made from polyvinylchloride (PVC). This material is weather resistant. The front outer layer 12 may alternatively be made from aluminium foil.

The rear outer layer 14 is made from a material comprising polyester or nylon. This material minimises scratching of the exterior panel during placement of the pad 10 on the car 30.

The inner layer 16 is made from ethylene-vinyl acetate (EVA) foam. This material can absorb the impact of a door of a further vehicle.

The pad 10 is generally hexagonally shaped with a pair of rounded corners and a pair of inclined sides. The hexagonal shape allows the pad to conform to the side panels of the car 30. Specifically, the pair of inclined sides conform to the wheel arches of the car 30.

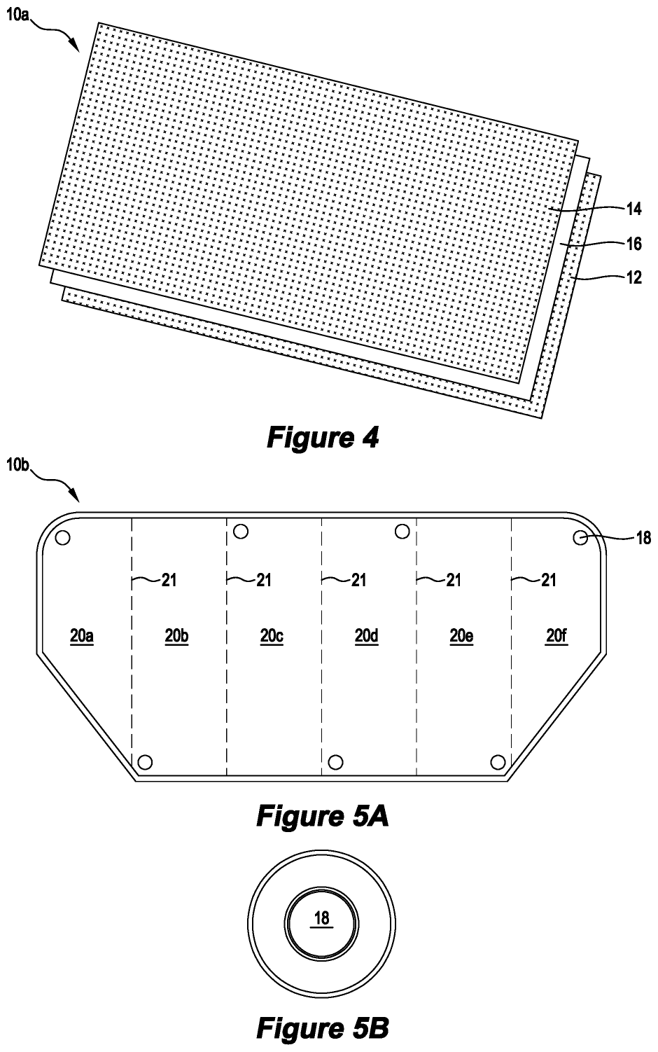

FIG. 4 shows a removable vehicle panel guard pad 10a according to another embodiment of the invention. The panel guard pad 10a functions in the same manner and has the same features as the removable vehicle panel guard pad 10. However, the pad 10a differs from the pad 10 in that it rectangular shaped and has no rounded corners.

FIG. 5A shows a removable vehicle panel guard pad 10b according to another embodiment of the invention. The panel guard pad 10b functions in the same manner and has the same features as the removable vehicle panel guard pad 10. However, the pad 10b has a plurality of magnetic securing element, in the form of button magnets 18, that are adapted to magnetically secure the pad 10b to the exterior panel of the vehicle. The button magnets 18 are located around a perimeter of the pad 10b. Each button magnet 18 is embedded within the inner layer 16 and is thus concealed within the outer layers 12, 14. This minimises the propensity for the button magnets 18 to scratch the exterior panel during placement of the pad 10b on the vehicle.

The pad 10b is divided into a plurality of sub-panels 20a-20f that are connected to each other and foldable relative to each other, via fold lines 21, to concertina between an extended configuration and a collapsed configuration.

A polyester edge trim 22 is stitched around the pad 10b to secure the outer layers 12, 14 together. Optionally, the polyester edge trim 22 may also secure the outer layers 12, 14 to the inner layer 16.

FIG. 5B shows an enlarged view of the button magnet 18 which is a disk shaped ferromagnet.

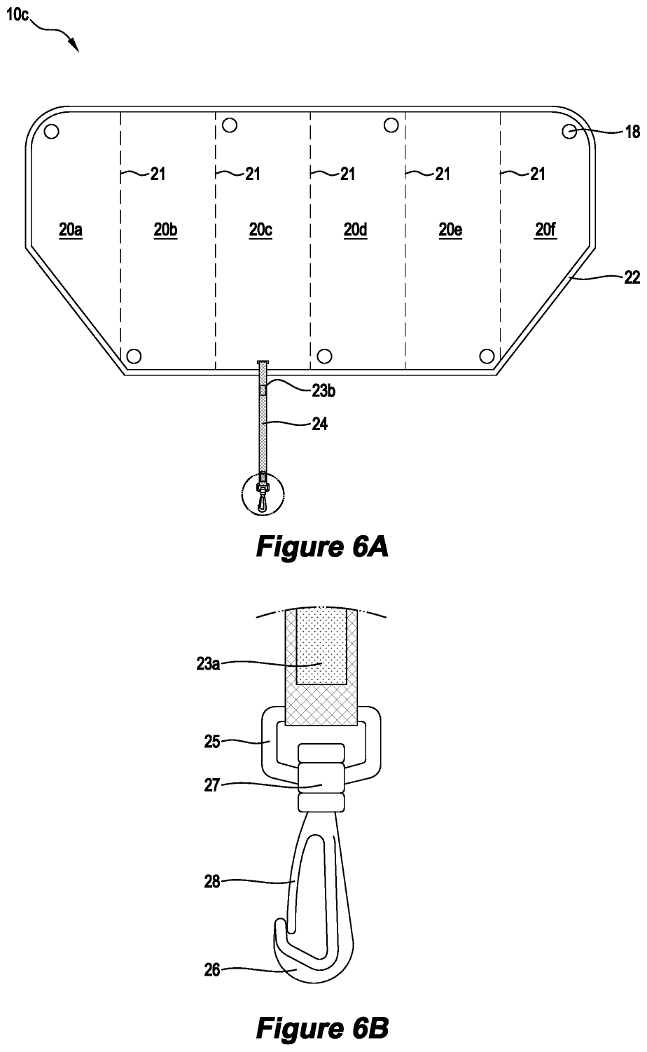

FIG. 6A shows a removable vehicle panel guard pad 10c according to another embodiment of the invention. The panel guard pad 10c functions in the same manner and has the same features as the removable vehicle panel guard pad 10b with the exception of the following additional features.

The pad 10c also comprises a tether, in the form of an inelastic belt 24, with an engagement element, in the form of a hook 26, that is configured to engage with a belt buckle inside the car 30. The hook 26 is made from a metal alloy.

The inelastic belt 24 comprises a fastening element, in the form of first and second hook and loop (e.g., Velcro®) portions 23a, 23b, for securing the pad 10c in the collapsed configuration. The first hook or loop portion 23a, located on a rear surface of the inelastic belt 24, that has hook/loop fasteners that interact with corresponding hook/loop fasteners on the second hook or loop portion 23b to secure the pad 10c in the collapsed configuration. The second hook or loop portion 23b is located on a front surface of the inelastic belt 24 and is offset from an end of the belt 24 that is secured to the pad by approximately 175 mm.

The end of the inelastic belt 24 is secured to the pad 10c via stitching.

However, it may be appreciated that the inelastic belt 24 may be secured to the pad 10c via any other means known in the art. For example, the pad 10c may have a slot through which an end of the belt 24 is threaded through, looped around the pad 10c and secured to itself using any means known in the art, for example fasteners, adhesives or ultrasonic welding.

As shown in FIG. 6B, an end of the belt 24 has a buckle 25 with a rotatable joint, i.e. swivel joint 27, that connects to the hook 26. The swivel joint 27 allows the belt 24 to be oriented such that it can be fed through a gap between the window and the window frame or a gap between the door and the door frame irrespective of the orientation of the hook 26.

The hook 26 defines an opening and comprises a latch 28 which in a closed position restricts access to the opening. The latch 28 can be moved to an open position in which access to the opening is relatively unrestricted. The latch 28 is resiliently biased towards the closed position. The latch 28 may be resiliently biased by way of a spring. Alternatively, the latch 28 may be made from an elastically material such that it is biased towards an undeformed shape.

Whilst in the embodiments described in FIGS. 5A and 6A the pads 10b, 10c have six sub-panels, it can be appreciated that the pad may have any number of panels to suit vehicles of different lengths.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

### EXEMPLARY ASPECTS

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1. A removable vehicle panel guard pad to protect an exterior panel of a vehicle from external damage, the pad comprising:

a weather resistant front outer layer;

a rear outer layer adapted to minimise scratching of the exterior panel during placement of the pad on the exterior panel of the vehicle;

an inner layer adapted to absorb the impact of any contact of the exterior panel by an external element, such as a door of another vehicle, the inner layer having a magnetic securing element that is adapted to magnetically secure the pad to the exterior panel of the vehicle; and

a tether adapted to secure the pad to an attachment point inside the vehicle.

Aspect 2. The removable vehicle panel guard pad of aspect 1, wherein the pad is flexible.

Aspect 3. The removable vehicle panel guard pad of aspect 2, wherein the pad is divided into a plurality of sub-panels that are connected to each other and foldable relative to each other between an extended configuration and a collapsed configuration.

Aspect 4. The removable vehicle panel guard pad of aspect 3, wherein the sub-panels are concertinaed.

Aspect 5. The removable vehicle panel guard pad of aspect 3 or aspect 4, further comprising a fastening element for securing the pad in the collapsed configuration.

Aspect 6. The removable vehicle panel guard pad of any one of the preceding aspects, wherein the front and rear outer layers are both weather resistant.

Aspect 7. The removable vehicle panel guard pad of any one of the preceding aspects, wherein the front and rear outer layers are both adapted to minimise scratching the pad on the exterior panel of the vehicle.

Aspect 8. The removable vehicle panel guard pad of any one of the preceding aspects, wherein the at least one inner layer is a composite.

Aspect 9. The removable vehicle panel guard pad of any one of the preceding aspects, comprising a plurality of magnets, each magnet located about a perimeter of the pad.

Aspect 10. The removable vehicle panel guard pad of any one of the preceding aspects, wherein the tether has an engagement element that is configured to engage with the attachment point inside the vehicle and the tether is rotatably connected to the engagement element.

Aspect 11. The removable vehicle panel guard pad of aspect 10, wherein the engagement element is a hook.

It will be understood to persons skilled in the art of the invention that many modifications may be made without departing from the spirit and scope of the invention.

1. A removable vehicle panel guard pad to protect an exterior panel of a vehicle from external damage, the removable vehicle panel guard pad comprising:
a weather resistant front outer layer;
a rear outer layer adapted to minimise scratching of the exterior panel during placement of the removable vehicle panel guard pad on the exterior panel of the vehicle;
an inner layer adapted to absorb the impact of any contact of the exterior panel by an external element the inner layer having a magnetic securing element that is adapted to magnetically secure the removable vehicle panel guard pad to the exterior panel of the vehicle; and
a tether adapted to secure the removable vehicle panel guard pad to an attachment point inside the vehicle.

2. The removable vehicle panel guard pad of claim 1, wherein the removable vehicle panel guard pad is flexible.

3. The removable vehicle panel guard pad of claim 2, wherein the removable vehicle panel guard pad is divided into a plurality of sub-panels that are connected to each other and foldable relative to each other between an extended configuration and a collapsed configuration.

4. The removable vehicle panel guard pad of claim 3, wherein the sub-panels are concertinaed.

5. The removable vehicle panel guard pad of claim 3, further comprising a fastening element for securing the removable vehicle panel guard pad in the collapsed configuration.

6. The removable vehicle panel guard pad of claim 1, wherein the front and rear outer layers are both weather resistant.

7. The removable vehicle panel guard pad of claim 1, wherein the front and rear outer layers are both adapted to minimise scratching the removable vehicle panel guard pad on the exterior panel of the vehicle.

8. The removable vehicle panel guard pad of claim 1, wherein the at least one inner layer is a composite.

9. The removable vehicle panel guard pad of claim 1, comprising a plurality of magnets, each magnet of the plurality of magnets located about a perimeter of the removable vehicle panel guard pad.

10. The removable vehicle panel guard pad of claim 1, wherein the tether has an engagement element that is configured to engage with the attachment point inside the vehicle and the tether is rotatably connected to the engagement element.

11. The removable vehicle panel guard pad of claim 10, wherein the engagement element is a hook.
